(19) United States
(12) Patent Application Publication
(10) Pub. No.: US 2008/0264125 A1
(43) Pub. Date: Oct. 30, 2008

(54) Lock assembly with an improved burglarproof lock core

(76) Inventors: Hsiu-Chuan Wu, Kanding Hsiang (TW); I-Chien Hsin, Banciao City (TW)

Correspondence Address: Joe McKinney Muncy, PO Box 1364, Fairfax, VA, 22038-1364, US

(21) Appl. No.: 11/790,237

(22) Filed: Apr. 24, 2007

(51) Int. Cl. E05B 15/12

(52) U.S. Cl. 70/416

(57) ABSTRACT

A lock assembly with an improved burglarproof lock core has a casing, a lock core and multiple outer chambers. The casing is mounted in a lock device and has a core hole and multiple outer chambers. The lock core is mounted in the core hole and has multiple inner chambers and a keyhole. The inner chambers correspond to the outer chambers in the casing. Each locking pin assembly is mounted slidably in the corresponding outer and inner chambers and has an inner and outer locking. The inner locking pins are flush with the inner chamber when the lock device is unlocked, and at least one inner locking pin is magnetic. The outer locking pin corresponding to the magnetic locking pin is held to ensure that the lock assembly won't be unlocked when someone attempts to tap the locking pin assemblies to pick the lock device.

### BACKGROUND OF THE INVENTION

1. Field of the Invention

The present invention relates to a lock, and more particularly to a lock assembly with an improved burglarproof lock core.

2. Description of the Prior Arts

With reference to FIGS. 11 and 12, a conventional lock assembly in accordance with the prior art comprises a casing (60), a lock core (61) and multiple locking pin assemblies (62).

The casing (60) is mounted in a door or some other places that needs to be locked and has a core hole (601) and multiple outer chambers (602);

The core hole (601) is circular and is formed longitudinally in the casing (60);

The outer chambers (602) are formed in a longitudinal line side by side in the casing (60) and communicate with the core hole (601).

The lock core (61) is mounted coaxially and rotatably in the core hole (601) in the casing (60) and has a front end, an outer surface, multiple inner chambers (611) and a keyhole (612).

The inner chambers (611) are formed through the outer surface of the lock core (61) and correspond respectively to and align with the outer chambers (602) in the casing (60) when the conventional lock assembly is locked, and each inner chamber (611) has an outer end.

The keyhole (612) is formed longitudinally in the front end of the lock core (61) and allows a corresponding key to be inserted into and to unlock the conventional lock assembly.

The locking pin assemblies (62) are mounted slidably respectively in the outer chambers (602) and the inner chambers (611), and each locking pin assembly (62) has an inner locking pin (622) and an outer locking pin (621).

The inner locking pins (622) are mounted slidably respectively in the inner chambers (611) and are flush respectively with the outer ends of the inner chambers (611) when the corresponding key is inserted in the keyhole (612).

Each outer locking pin (621) is mounted slidably in the outer chamber (602) and the inner chamber (611) and is mounted in the outer chamber (602) and the inner chamber (611) to keep the conventional lock assembly locked. When the corresponding key is inserted into the keyhole (612), the outer locking pins (621) pressed out of the inner camber (611) by the corresponding inner locking pins (622) to unlock the conventional lock assembly. However, the outer locking pins (621) may be pressed completely into the outer chamber (602) with a tool to open the lock device without using the corresponding key.

To overcome the shortcomings, the present invention provides a lock assembly with an improved burglarproof lock core to mitigate or obviate the aforementioned problems.

### SUMMARY OF THE INVENTION

The primary objective of the present invention is to provide a lock assembly that a lock device from being picked.

A lock assembly with an improved burglarproof lock core has a casing, a lock core and multiple outer chambers. The casing is mounted in a lock device and has a core hole and multiple outer chambers. The lock core is mounted in the core hole and has multiple inner chambers and a keyhole. The inner chambers correspond respectively to the outer chambers in the casing. The keyhole allows a corresponding key to be inserted into the core. Each locking pin assembly is mounted slidably in the corresponding outer and inner chambers and has an inner and an outer locking pin. The inner locking pins are flush with the inner chamber when the lock device is unlocked, and at least one inner locking pin is magnetic. The outer locking pin corresponding to the magnetic locking pin is held to ensure that the lock assembly won't be unlocked when someone attempts to tap the individual locking pin assemblies and pick the lock device.

Other objectives, advantages and novel features of the invention will become more apparent from the following detailed description when taken in conjunction with the accompanying drawings.

### BRIEF DESCRIPTION OF THE DRAWINGS

FIG. 1 is a front view in partial section of a first embodiment of a lock assembly with an improved burglarproof lock core in accordance with the present invention;

FIG. 2 is a side view in partial section of the lock assembly in FIG. 1;

FIG. 3 is an operational side view in partial section of the lock assembly in FIG. 1 when a corresponding key is inserted into the lock core;

FIG. 4 is an operational front view in partial section of the lock assembly along line 4-4 in FIG. 3 when a corresponding key is inserted into the lock core;

FIG. 5 is an operational front view in partial section of the lock assembly in FIG. 4 when a corresponding key is inserted into and rotates the lock core;

FIG. 6 is a front view in partial section of a second embodiment of the lock assembly in accordance with the present invention;

FIG. 7 is a side view in partial section of the lock assembly in FIG. 6;

FIG. 8 is an operational side view in partial section of the lock assembly in FIG. 6 when the corresponding key is inserted into the lock core;

FIG. 9 is an operational front view in partial section of the lock assembly along line 9-9 in FIG. 8 when the corresponding key is inserted into the lock core;

FIG. 10 is an operational front view in partial section of the lock assembly in FIG. 8 when the corresponding key is inserted into and rotates the lock core;

FIG. 11 is a side view in partial section of a conventional lock assembly in accordance with the prior art; and

FIG. 12 is a front view in partial section of the conventional lock assembly in FIG. 11.

### DETAILED DESCRIPTION OF THE PREFERRED EMBODIMENTS

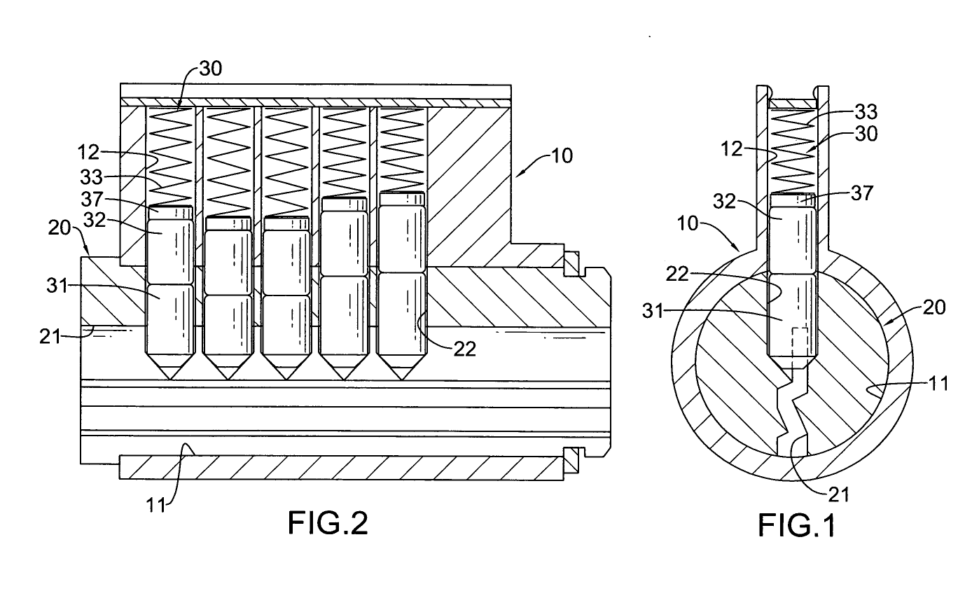

With reference to FIGS. 1 and 2, a lock assembly with an improved burglarproof lock core in accordance with the present invention comprises a casing (10), a lock core (20) and multiple locking pin assemblies (30).

The casing (10) is mounted in a lock device and has a core hole (11) and multiple outer chambers (12).

The core hole (11) is circular and is formed longitudinally in the casing (10).

The outer chambers (12) are formed in the casing (11), may be formed in a longitudinal line side by side and transversely communicate with the core hole (11).

The lock core (20) is mounted coaxially and rotatably in the core hole (11) in the casing (10) and has a front end, an outer surface, multiple inner chambers (22) and a keyhole (21).

The inner chambers (22) are formed through the outer surface of the lock core (20) and correspond respectively to and selectively align respectively with the outer chambers (12) in the casing (10), and each inner chamber (22) has an outer end and an inner end. The outer ends align respectively with the outer chambers (12) when the lock assembly is locked.

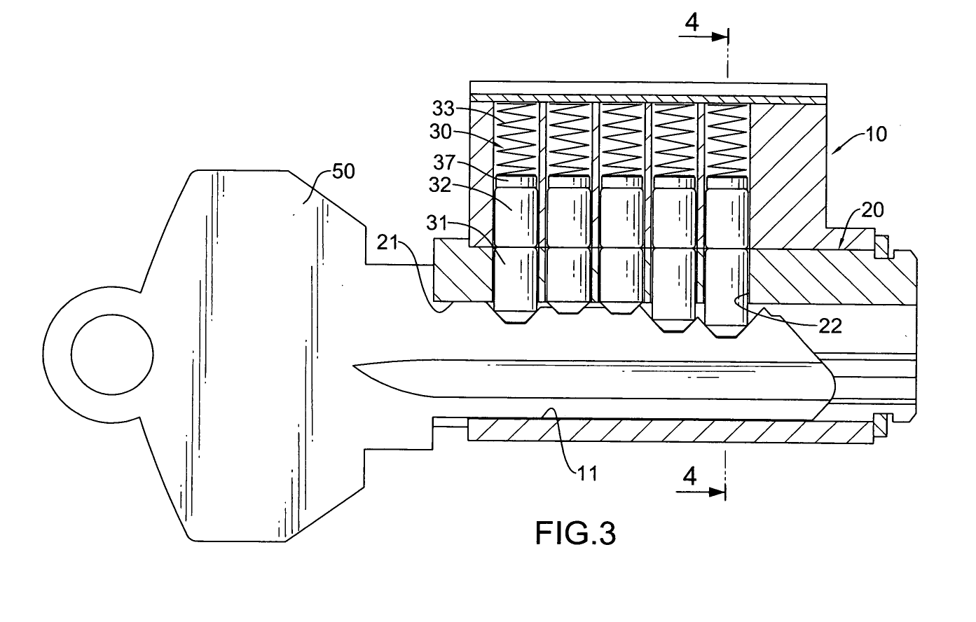

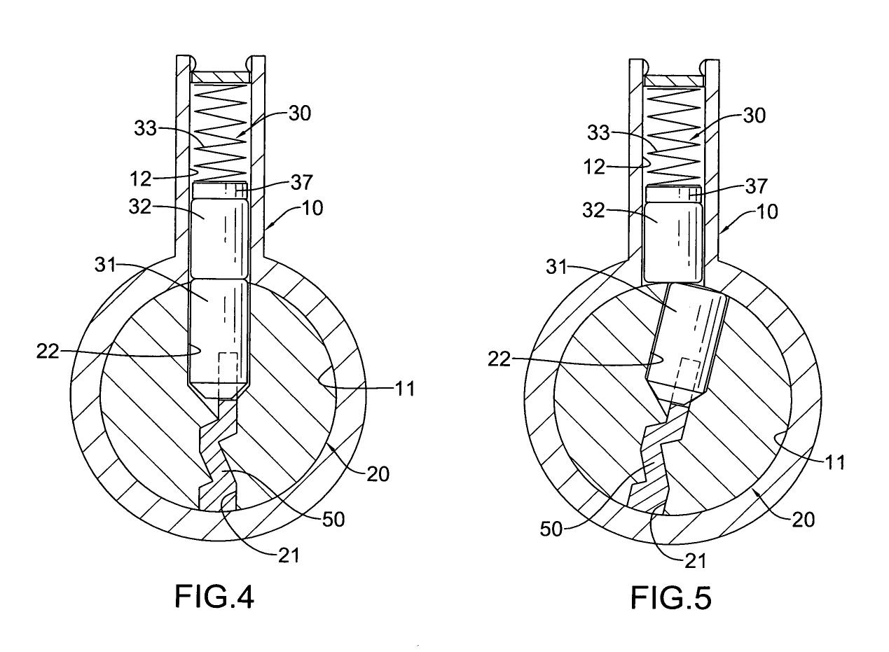

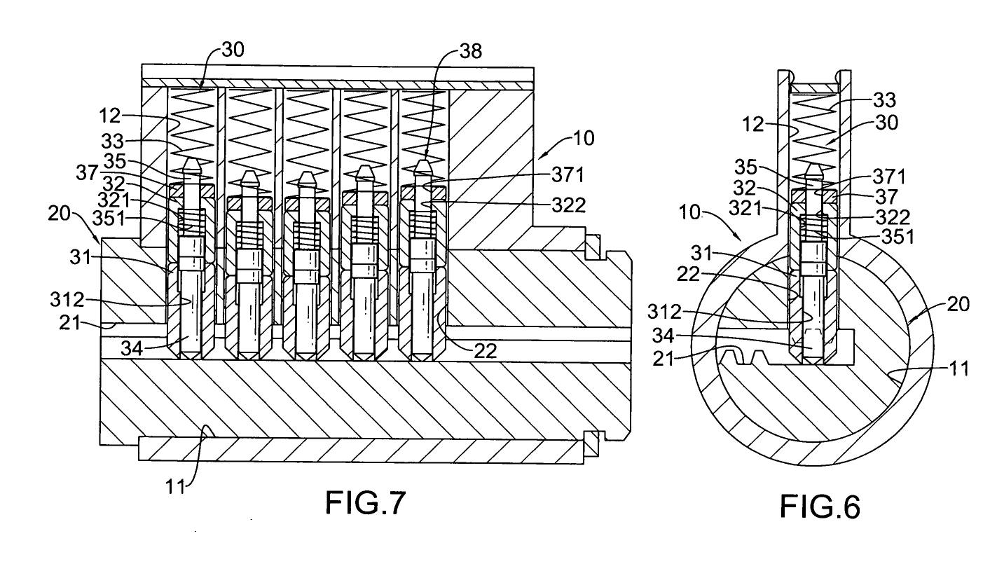

With further reference of FIGS. 3 to 5, the keyhole (21) is formed longitudinally in the front end of the lock core (20), communicates with the inner ends of the inner chambers (22), allows a corresponding key (50) to be inserted into the lock core (20) and may have a side surface and a top edge or an inner surface. With further reference of FIGS. 6 and 7, the side surface or the top edge of the keyhole (21) may communicate with the inner ends of the inner chambers (22).

The locking pin assemblies (30) are mounted slidably respectively in corresponding outer chambers (12) and inner chambers (22), and each locking pin assembly (30) has an inner locking pin (31), an outer locking pin (32), a pressing plate (37) and a spring (33), and at least one locking pin assembly (30) may have a supplementary locking pin assembly (38).

The inner locking pins (31) are mounted slidably respectively in the corresponding inner chambers (22), extend into the keyhole (21) and are pressed flush with the outer ends of the inner chambers (22) when the corresponding key (50) is inserted into the keyhole (21). At least one of the inner locking pins (31) is magnetic, and at least one of the inner locking pins (31) may have a through hole (312). When the inner locking pins (31) are flush with the outer ends of the inner chambers (22), turning the key (50) rotates the lock core (20) and unlocks the lock device. The through hole (312) is formed coaxially through the inner locking pin (31).

The outer locking pins (32) are mounted slidably respectively in the outer chambers (12) and selectively extend respectively into the corresponding inner chambers (22) to keep the lock core (20) from rotating, each outer locking pin (32) has an outer end and an inner end, and at least one of the outer locking pins (32) may have a recess (321) and a through hole (322). The at least one the outer locking pin (32) corresponding to the magnetic inner locking pin (31) is held by the magnetic inner locking pin (31) to ensure that the lock assembly won't separate from the magnetic inner locking pin (31) easily by a tool and keep the lock device from being picked easily. The recess (321) is formed coaxially in the inner end of the outer locking pin (32), selectively communicates with the through hole (312) in the corresponding inner locking pin (31) and has a bottom. The through hole (322) is formed coaxially in the bottom of the recess (321) and communicates with the recess (321).

Each pressing plate (37) is non-magnetic, is mounted on the outer end of the corresponding outer locking pin (32), prevents the outer locking pin (32) from moving when someone taps the locking pin assemblies (30) with a tool and has an outer end and an optional through hole (371). The through hole (371) is formed coaxially in the pressing plate (37) and corresponds to the through hole (312) in the corresponding outer locking pin (31).

Each spring (33) is mounted between the casing (10) and the outer end of the corresponding pressing plate (37) and presses the pressing plate (37) against the outer locking pin (32).

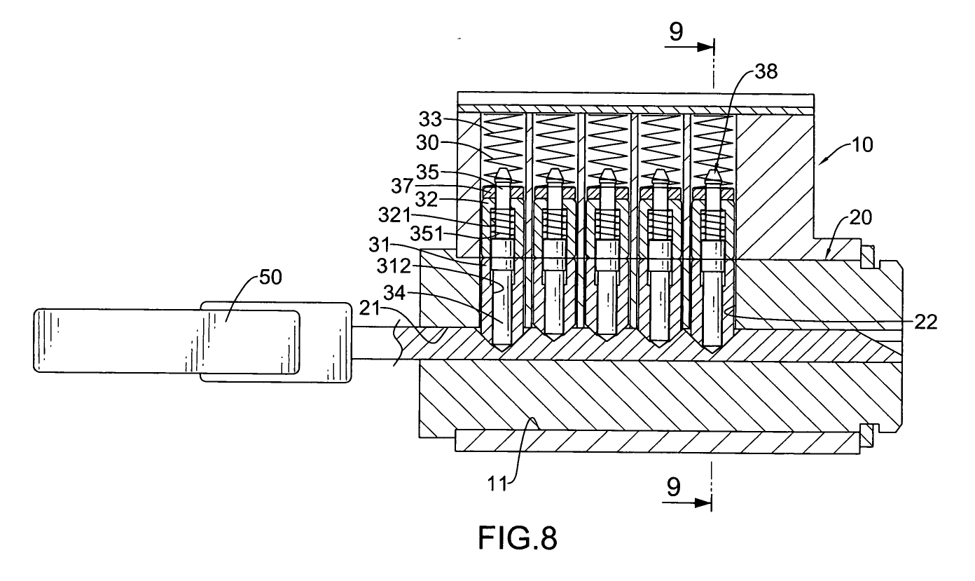

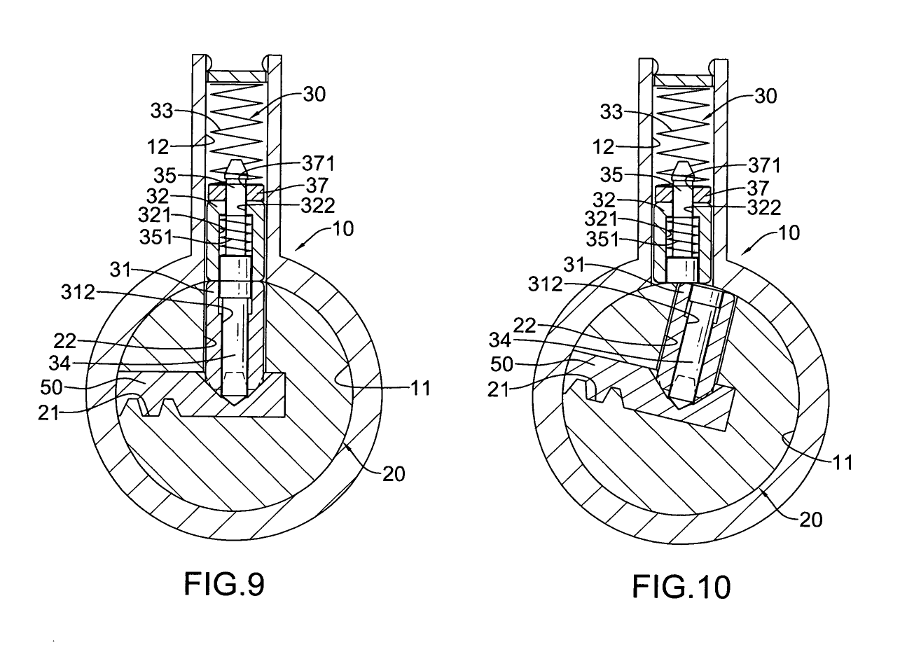

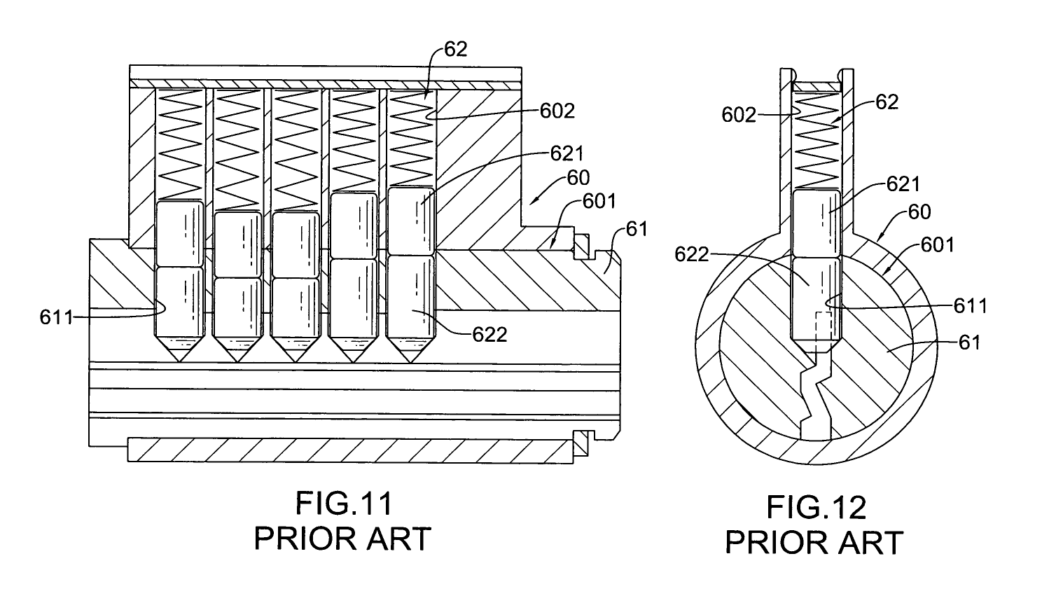

With further reference of FIGS. 8 to 10, the supplementary locking pin assembly (38) has an inner supplementary locking pin (34) and an outer supplementary locking pin (35).

The inner supplementary locking pin (34) is mounted slidably in the through hole (312) in the corresponding inner locking pin (31), alternatively extends into the keyhole (21) or into the recess (321) in the corresponding outer locking pin (32) and has an inner end and an outer end. The inner end of the inner supplementary locking pin (34) is pressed by the corresponding key (50) to press the outer end of the inner supplementary locking pin (34) flush with the outer end of inner chamber (22) when the corresponding key (50) is inserted into the keyhole (21). When no corresponding key (50) is inserted into the keyhole (21), the inner supplementary locking pin (34) extends into the recess (321) in the corresponding outer locking pin (32) to further prevent the lock core (20) from rotating.

The outer supplementary locking pin (35) is mounted slidably in the recess (321) and the through hole (322) in the corresponding outer locking pin (32) and has an outer end, a inner end and a supplementary spring (351). The outer end of the outer supplementary locking pin (35) extends out of the through hole (322) in the corresponding outer locking pin (32) and the through hole (371) in the corresponding pressing plate (37). The lower inner end of the upper outer supplementary locking pin (35) abuts the upper outer end of the corresponding lower inner supplementary locking pin (34). The supplementary spring (351) is mounted around the outer supplementary locking pin (35) between the bottom of the corresponding recess (321) and the inner end of the outer supplementary locking pin (35).

Therefore, the lock assembly with an improved burglarproof lock core provides an improved security to ensure that the lock assembly won't be unlocked when someone who attempts to tap the locking pin assemblies illegally.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A lock assembly comprising
a casing having
a core hole being circular and being formed longitudinally in the casing; and
multiple outer chambers being formed in the casing and transversely communicating with the core hole;
a lock core being mounted coaxially and rotatably in the core hole in the casing and having
a front end;
an outer surface;
multiple inner chambers being formed through the outer surface of the lock core and corresponding respectively to and selectively aligning respectively with the outer chambers in the casing, and each inner chamber having
an outer end; and
a inner end; and
a keyhole being formed longitudinally in the front end of the lock core, communicating with the inner ends of the inner chambers; and
multiple locking pin assemblies being mounted slidably respectively in the outer chambers and inner chambers; and each locking pin assembly having
an inner locking pin being mounted slidably in a corresponding inner chamber, extending into the keyhole and being selectively pressed flush with the outer end of the corresponding inner chamber, and at least one of the inner locking pins being magnetic;
an outer locking pin being mounted slidably in a corresponding outer chamber, selectively extending into the corresponding inner chamber and having an outer end and an inner end, wherein at least one of the outer locking pins is held by a corresponding one of the at least one magnetic inner locking pin;
a pressing plate being non-magnetic, being mounted on the outer end of the outer locking pin and having an outer end; and
a spring being mounted between the casing and the outer end of the pressing plate and pressing the pressing plate against the outer locking pin.

2. The lock assembly as claimed in claim 1, wherein
at least one of the inner locking pins has a through hole formed coaxially through the inner locking pin; and
at least one of the outer locking pins has
a recess formed coaxially in the inner end of the outer locking pin, corresponding to the through hole of the corresponding inner locking pin, selectively communicating with the through hole in the corresponding inner locking pin and having a bottom; and
a through hole formed coaxially in the bottom of the recess and communicating with the recess; and
at least one of the pressing plates further has an through hole formed coaxially in the pressing plate and corresponding to the through hole in a corresponding outer locking pin; and
at least one of the pin assemblies has a supplementary locking pin assembly having
an inner supplementary locking pin mounted slidably in the through hole in a corresponding inner locking pin, alternatively extending into the keyhole and the recess in a corresponding outer locking pin and having
an inner end; and
an outer end; and
an outer supplementary locking pin mounted slidably in the recess and the through hole in the corresponding outer locking pin and having
an outer end extending out of the through hole in the corresponding outer locking pin and the through hole in a corresponding pressing plate;
an inner end abutting the outer end of the inner supplementary locking pin; and
a supplementary spring mounted around the supplementary outer locking pin between the bottom of the corresponding recess and the inner end of the outer supplementary locking pin.

3. The lock assembly as claimed in claim 1, where in at least one of the outer locking pins of the locking pin assemblies is magnetic; and
at least one of the inner locking pins of the locking pin assemblies is held by a corresponding one of the at least one magnetic outer locking pin.

4. The lock assembly as claimed in claim 1, where in the keyhole further has a side surface communicating with the inner ends of the inner chambers in the lock core.

5. The lock assembly as claimed in claim 1, where in the keyhole further has a top edge communicating with the inner ends of the inner chambers in the lock core.
